(19) United States
(12) Patent Application Publication
(10) Pub. No.: US 2004/0062320 A1
(43) Pub. Date: Apr. 1, 2004

(54) Time dispersion symbol encoding/decoding

(76) Inventor: Dean Gienger, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/263,144

(22) Filed: Oct. 1, 2002

(51) Int. Cl. H04L 27/04

(52) U.S. Cl. 375/295

(57) ABSTRACT

An encoder uses orthogonal dispersion sequences to encode symbols of an applied symbol stream as a series of microbursts that are separated by variable time intervals established by the time dispersion sequences. A decoder selects one or more series of microbursts from a composite set of microbursts received by the decoder, based on dispersion sequences at the decoder that match the dispersion sequences used to encode the one or more series of microbursts. Each selected series of microbursts is then conditioned to extract a corresponding symbol stream.

### FIELD OF THE INVENTION

This invention relates to communication systems, and particularly, to symbol encoding/decoding within the communication systems.

### BACKGROUND OF THE INVENTION

In many types of digital communications systems, multiple symbol streams are collectively transmitted between a transmitter and receiver over a cable, optical fiber, radio channel or other transmission medium or link. Digital information represented by symbols in the symbol streams is typically encoded and modulated by the transmitter and then introduced to the transmission medium. At a receiver, decoding recovers the symbols in each of the multiple symbol streams. The symbol streams are encoded and decoded based on fixed time slots in a TDMA (time domain multiple access) scheme, whereas in a CDMA (code domain multiple access) scheme, orthogonal codes are used to encode and decode the symbol streams. However, independent of the scheme employed, performance of a digital communication system is enhanced when coding gain is provided by the encoding/decoding of symbols within the symbol streams, and when the effects of multi-path distortions and other problematic characteristics inherent in the transmission medium are reduced.

### SUMMARY OF THE INVENTION

A symbol encoder and decoder, constructed according to alternative embodiments of the present invention, provides coding gain and enables the effects of multi-path distortions within transmission media on the symbol streams to be reduced. According to one embodiment of the present invention, an encoder uses dispersion sequences to encode symbols of an applied symbol stream by generating a series of microbursts that are separated by variable time intervals established by the dispersion sequences. The series of microbursts are suitable for combining into a composite set of microbursts for transmission within a communication system. When two or more symbol streams are applied to the encoder, each of the symbol streams is encoded according to a corresponding dispersion sequence, where the multiple dispersion sequences are orthogonal. Coding gain is provided because the series of microbursts are generated according to a burst rate that exceeds the symbol rate of the corresponding symbol stream, resulting in multiple microbursts being generated for each symbol encoded by the encoder. By establishing the variable time intervals separating the microbursts in each series of microbursts to be at least as long as time differentials between primary propagation paths through the transmission medium, the effect of multipath distortion is reduced, thereby reducing inter-symbol interference (ISI) and enhancing the performance of the communication system in which the encoder is used.

According to another embodiment of the present invention, a decoder selects one or more series of microbursts from a composite set of microbursts based on dispersion sequences at the decoder that match the dispersion sequences used to encode the one or more series of microbursts. Each selected series of microbursts is then conditioned to reconstruct or otherwise extract a corresponding symbol stream. Symbol encoding and decoding methods are constructed according to alternative embodiments of the present invention.

### BRIEF DESCRIPTION OF THE DRAWINGS

FIG. 1 shows an example of a communication system that includes an encoder and a decoder constructed according to alternative embodiments of the present invention.

FIG. 2 shows an encoder constructed according to a first embodiment of the present invention.

FIG. 3 shows an example timing diagram associated with the encoder and decoder constructed according to the embodiments of the present invention.

FIG. 4 shows a flow diagram of a symbol encoding method constructed according to a second embodiment of the present invention.

FIG. 5 shows a decoder constructed according to a third embodiment of the present invention.

FIG. 6 shows an example of a pilot synchronization system for use with the decoder constructed according the third embodiment of the present invention.

FIG. 7 shows a flow diagram of a symbol decoding method constructed according to a fourth embodiment of the present invention.

### DETAILED DESCRIPTION OF THE EMBODIMENT

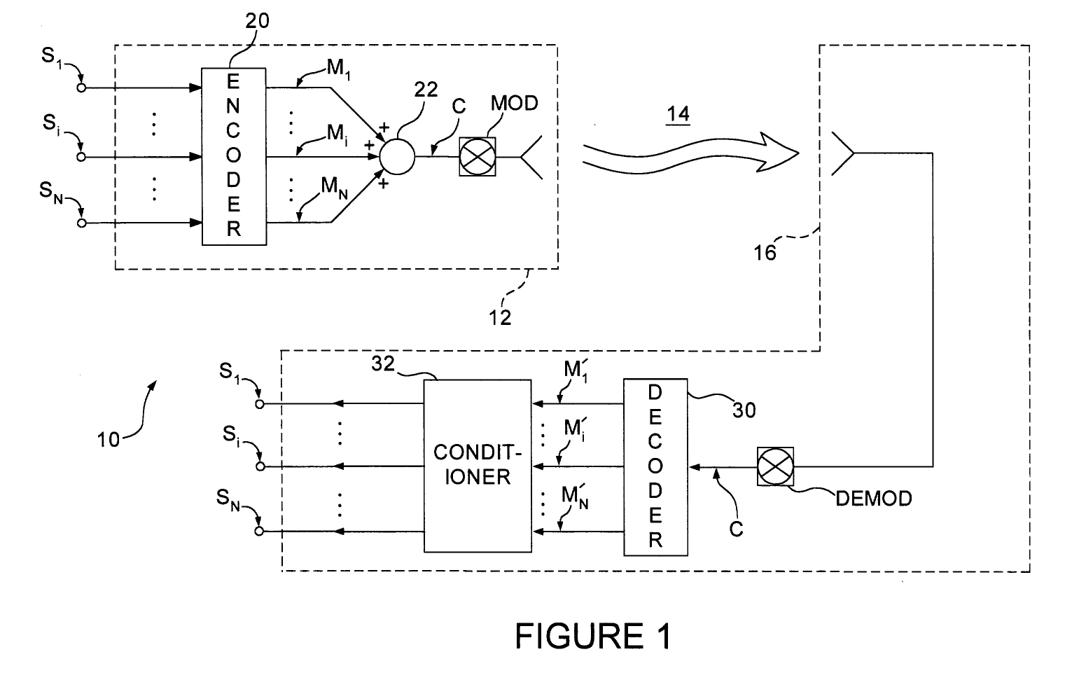

FIG. 1 shows an example of a communication system 10 that includes an encoder 20 and a decoder 30 constructed according to alternative embodiments of the present invention. One or more symbol streams S₁-S_{N} are provided to a transmitter 12 that includes the encoder 20. The encoder 20 represents each of the symbol streams S₁-S_{N} by a corresponding series of microbursts M₁-M_{N}. Typically, the one or more series of microbursts M₁-M_{N} are combined by a combiner 22 to form a composite set of microbursts C suitable for modulation by one or more modulators MOD and placement on a transmission medium 14 such as a cable, optical fiber, waveguide or other physical structure suitable for transmission of encoded information. Alternatively, the composite set of microbursts C representing the symbol streams S₁-S_{N} is transmitted via a radio channel, satellite link or other system that provides for propagation of encoded information between remote locations.

A receiver 16 including the decoder 30 intercepts, from the transmission medium 14, the composite set of microbursts C as modulated within the transmitter 12. Once the composite set of microbursts are demodulated by a demodulator DEMOD within the receiver 16, the decoder 30 selects microbursts from the composite set of microbursts C at the variable time intervals established by the encoder 20 to provide one or more received series of microbursts M′₁-M′_{N}. A conditioner 32 coupled to the decoder 30 then extracts the symbol streams S₁-S_{N} that correspond to the received series of microbursts M′₁-M′_{N}.

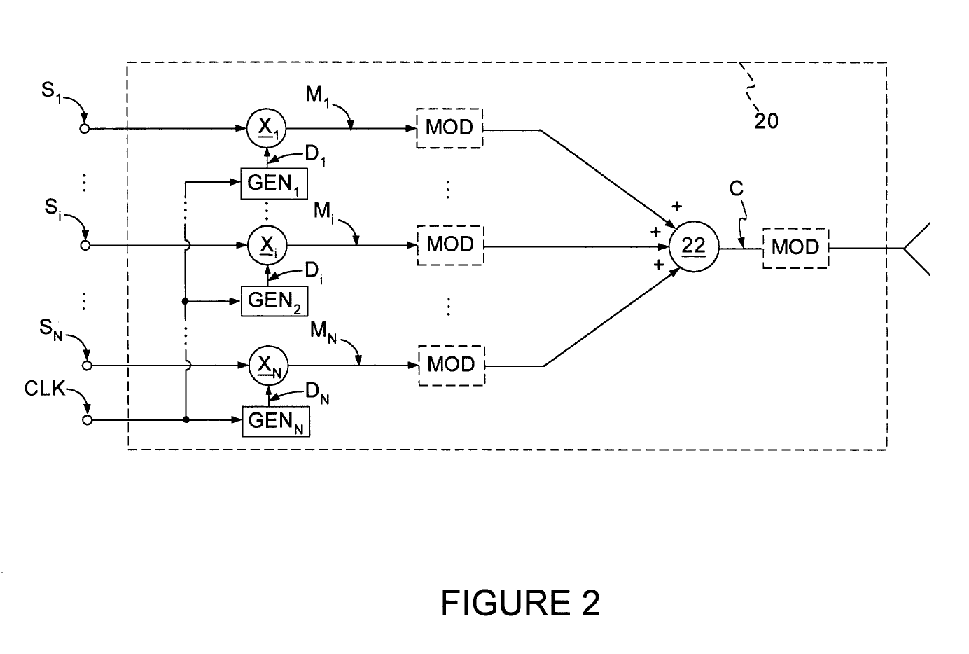

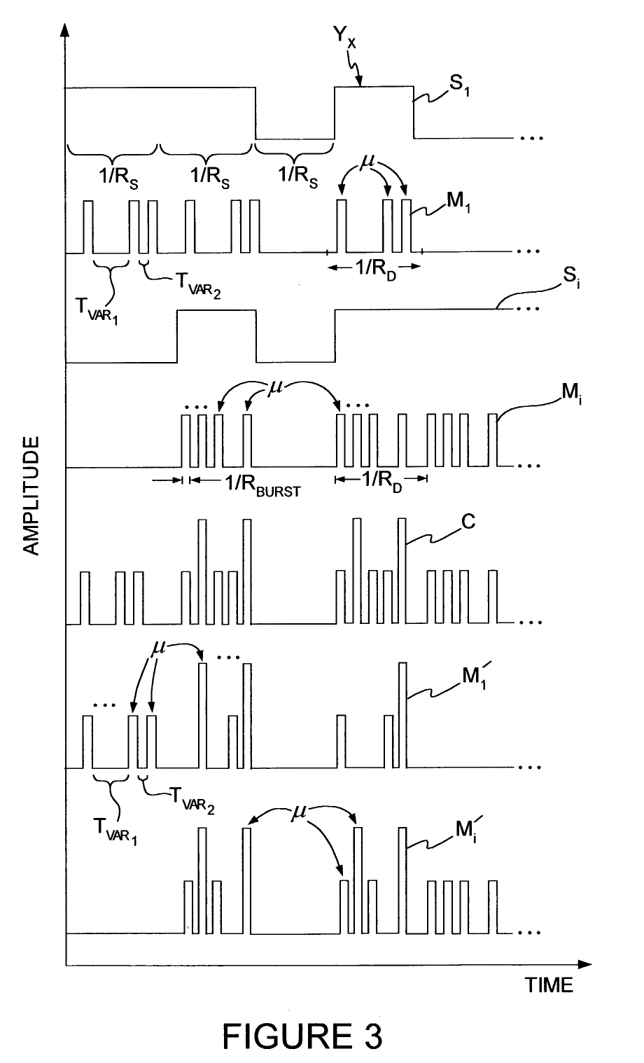

FIG. 2 shows a detailed view of the encoder 20 constructed according to a first embodiment of the present invention. The encoder 20 includes one or more variable time interval samplers X₁-X_{N} that each receive a corresponding one of the symbol streams S₁-S_{N}. As applied to the encoder 20, the one or more symbol streams S₁-S_{N} are synchronous with each other. Typically the synchronization results from referencing the symbol streams S₁-S_{N} to a common clock, or from re-clocking the symbol streams S₁-S_{N} to a common reference (not shown). However, while the symbol streams S₁-S_{N} are synchronized to have an established timing relationship, the symbol rates R_{S} or symbol periods 1/R_{S} (shown in FIG. 3) within each of the symbol streams S₁-S_{N} need not be the same.

One or more time dispersion code generators GEN₁-GEN_{N} provide corresponding dispersion sequences D₁-D_{N}. While a separate time dispersion code generator is shown coupled to each of the variable time interval samplers X₁-X_{N}, a single time dispersion code generator with a multiplexed output is suitable for providing the corresponding dispersion sequences D₁-D_{N} to more than one of the variable time interval samplers X₁-X_{N}. Thus, while each of the variable time interval samplers X₁-X_{N} is provided with a corresponding one of the dispersion sequences D₁-D_{N}, the number of time dispersion code generators GEN₁-GEN_{N} in the encoder 20 need not be the same as the number of variable time interval samplers X₁-X_{N}.

The time dispersion code generators GEN₁-GEN_{N} activate the variable time interval samplers X₁-X_{N} so that each variable time interval sampler Xᵢ generates a corresponding series of microbursts Mᵢ separated by varying time intervals Tvarₓ (as shown in FIG. 3) established by the corresponding dispersion sequence Dᵢ provided by the time dispersion code generator GENᵢ. In an example implementation of the encoder 20, the variable time interval samplers X₁-X_{N} are multipliers, mixers, switches, amplitude modulators or pulse modulators, and the time dispersion code generators GEN₁-GEN_{N} are analog or digital hardware providing the dispersion sequences D₁-D_{N}, which are sequences of drive pulses separated by varying time intervals and provided to the variable time interval samplers X₁-X_{N}. This produces at the output of each of the variable time interval samplers X₁-X_{N}, corresponding series of microbursts M₁-M_{N} each having microbursts μ (shown in FIG. 3) that are timed at the varying time intervals Tvarₓ established by the corresponding dispersion sequences D₁-D_{N}. The example timing diagram of FIG. 3 shows the microbursts μ having amplitudes established according to the symbols Y_{X} applied to the inputs of the variable time interval samplers X₁-X_{N}. However, the microbursts μ alternatively have pulse shapes, pulse widths or other characteristics that are established according to the symbols Y_{X} applied to the inputs of the variable time interval samplers X₁-X_{N}.

The time dispersion code generators GEN₁-GEN_{N} are synchronized so that the series of microbursts M₁-M_{N} generated by the variable time interval samplers X₁-X_{N} have an established time relationship to each other. This synchronization is provided by a clock signal CLK or other suitable reference establishing a burst rate R_{BURST} that is coherent with the symbol streams S₁-S_{N} applied to the encoder 20. Typically, the burst rate R_{BURST} is an integer multiple of the symbol rate R_{S} of the symbol streams S₁-S_{N}, which provides a coding gain for the encoder 20. When continuous encoding of symbols Y_{X} within the symbol streams S₁-S_{N} is employed, each dispersion sequence Dᵢ can be repeated at a repetition rate R_{D} that coincides with the symbol rate R_{S} of the particular symbol stream Sᵢ encoded. In the example timing diagram of FIG. 3, symbol streams S₁, Sᵢ, corresponding series of microbursts M₁, Mᵢ, and a composite set of microbursts C that includes the series of microbursts M₁, Mᵢ are shown. The burst rate R_{BURST} and the symbol rates R_{S} are also indicated.

Depending on the type of communication system in which the encoder 20 is used, the one or more series of microbursts M₁-M_{N} are either transmitted independently, or combined into a composite set of microbursts C via the combiner 22, optionally included in the encoder 20 as shown in FIG. 2. The series of microbursts M₁-M_{N} are typically modulated collectively after the composite set of microbursts C is formed, or the series of microbursts M₁-M_{N} are modulated separately prior to combination into the composite set of microbursts C. FIG. 2 shows optionally included modulators MOD in these two alternative locations.

The dispersion sequences D₁-D_{N} provided by the time dispersion code generators GEN₁-GEN_{N} are orthogonal, where orthogonal means that the dispersion sequences D₁-D_{N} are sufficiently orthogonal to provide cross-correlations between each of the dispersion sequences D₁-D_{N} that are either zero, or sufficiently low to make each of the series of microbursts M₁-M_{N} statistically independent. As non-exclusive examples, these dispersion sequences D₁-D_{N} are Walsh codes generated using a Hadamard Transform, codes such as those included in the IS-95 digital cellular standard, or Orthogonal Variable Spreading Factor (OVSF) codes such as those included in the IMT2000 Wideband CDMA digital cellular standard.

As an alternative to the hardware implementation of the variable time interval samplers X₁-X_{N} and the time dispersion code generators GEN₁-GEN_{N}, the encoder 20 is implemented in software. In an example software implementation, the symbol streams S₁-S_{N} are digitized and sampled according to the corresponding dispersion sequences D₁-D_{N} mathematically in software, for example by multiplying the digitized symbol stream by vectors representing the dispersion sequences D₁-D_{N} as a series of ones separated by a varying number of zeroes. The product of the multiplication is then converted by analog-to-digital converters into the series of microbursts M₁-M_{N}. As a further alternative to the hardware and software implementations of the encoder 20, the encoder 20 is implemented using any suitable combination of hardware and software.

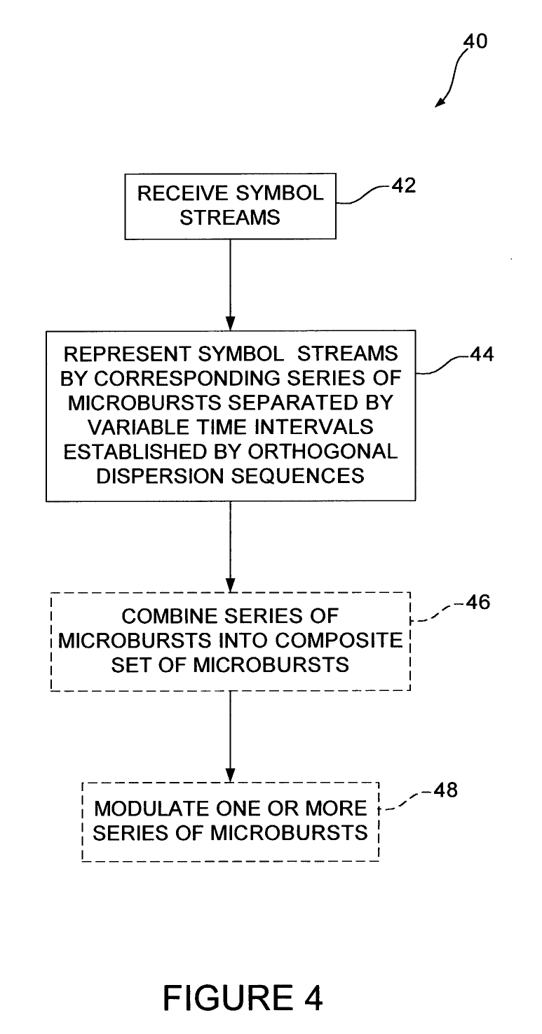

A symbol encoding method 40 is constructed according to a second embodiment of the present invention. FIG. 4 shows a flow diagram of the method 40. In step 42 of the method 40, the one or more symbol streams S₁-S_{N} are received. In step 44, the symbols Y_{X} within the symbol streams S₁-S_{N} are represented by the corresponding series of microbursts M₁-M_{N} each series Mᵢ including microbursts μ that are separated by variable time intervals Tvarₓ established by corresponding dispersion sequences D₁-D_{N}. Representation of the symbol streams S₁-S_{N} is provided by sampling, multiplying, mixing or modulating each of the symbol streams Sᵢ by a waveform or a vector, depicting the corresponding dispersion sequence Dᵢ used to establish the variable time intervals in the corresponding series of microbursts Mᵢ. When more than one of the symbol streams S₁-S_{N} is represented by the series of microbursts M₁-M_{N}, the dispersion sequences D₁-D_{N} are orthogonal, and each series of microbursts is coherent with the particular symbol stream encoded, thereby resulting in the multiple series of microbursts M₁-M_{N} being synchronous with each other. Orthogonal refers to the dispersion sequences D₁-D_{N} being sufficiently orthogonal to provide cross-correlations between each of the dispersion sequences D₁-D_{N} that are either zero, or sufficiently low to make each of the series of microbursts M₁-M_{N} statistically independent. Continuous encoding of the symbols Y_{X} within the symbol streams S₁-S_{N} is provided by repeating each of the dispersion sequences D₁-D_{N} at a repetition rate R_{D} that coincides with the symbol rate R_{S} of the particular symbol stream Sᵢ encoded according to the method 40.

In optionally included step 46, one or more series of microbursts M₁-M_{N} are combined to form the composite set of microbursts C. In optionally included step 48, modulation of the one or more series of microbursts M₁-M_{N} is performed independent of whether the step 46 is included in the method 40. When step 46 is included in the method 40, the modulation is performed prior to the combination of the series of microbursts or after the combination of the series of microbursts into the composite set C.

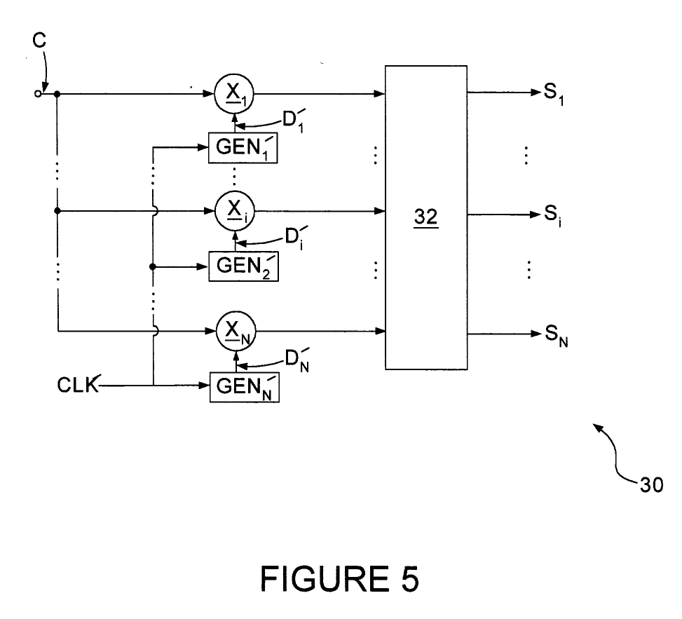

FIG. 5 shows a detailed view of the decoder 30 constructed according to a third embodiment of the present invention. Typically, the decoder 30 is coupled to a demodulator DEMOD within the receiver 16 (shown in FIG. 1) that receives from a transmission medium 14 the composite set of microbursts C as modulated by the transmitter 12. Once demodulated, the composite set of microbursts C is received by one or more variable time interval samplers X′₁-X′_{N} included in the decoder 30. One or more time dispersion code generators GEN′₁-GEN′_{N} provide corresponding dispersion sequences D′₁-D′_{N} used to drive each of the variable time interval samplers X′₁-X′_{N}. While a separate time dispersion code generator is shown coupled to each of the variable time interval samplers X′₁-X′_{N}, a single time dispersion code generator with a multiplexed output is suitable for providing the corresponding dispersion sequences D′₁-D′_{N} to more than one of the variable time interval samplers X′₁-X′_{N}. Thus, while each of the variable time interval samplers X′₁-X′_{N} is provided with a corresponding one of the dispersion sequences D′₁-D′_{N}, the number of time dispersion code generators GEN′₁-GEN′_{N} in the decoder 30 need not be the same as the number of variable time interval samplers X′₁-X′_{N}_{N}.

The time dispersion code generators GEN′₁-GEN′_{N} activate the variable time interval samplers to select one or more series of microbursts M′₁-M′_{N} from the composite set of microbursts C. This provides at the output of each of the variable time interval samplers X′₁-X′_{N}, corresponding series of microbursts M′₁-M′_{N} each having microbursts μ (shown in FIG. 3) that are timed at the varying time intervals Tvarₓ established by the corresponding dispersion sequences D′₁-D′_{N}. By matching the dispersion sequences D′₁-D′_{N} provided the decoder 30 to the dispersion sequences D₁-D_{N} provided in the encoder 20, microbursts μ within the composite set of microbursts C are selected at variable time intervals Tvarₓ equivalent to those forming each of the series of microbursts M₁-M_{N} established by the encoder 20. In an example implementation of the decoder 30, the variable time interval samplers X′₁-X′_{N} are multipliers, mixers, switches, amplitude modulators or pulse modulators and the time dispersion code generators GEN′₁-GEN′_{N} are analog or digital hardware providing the dispersion sequences D′₁-D′_{N} that are sequences of drive pulses spaced at varying time intervals and provided to the variable time interval samplers X′₁-X′_{N}.

The time dispersion code generators GEN′₁-GEN′_{N} are synchronized to each other by a clock signal CLK′ or other suitable reference derived from, or synchronized to, the burst rate R_{BURST} used to time the generation of the series of microbursts M₁-M_{N} in the encoder 20, so that the acquired samples from the composite set of microbursts C by each of the variable time interval samplers X′₁-X′_{N} provide the received series of microbursts M′₁-M′_{N} that have an established time relationship to each other. The variable time interval samplers X′₁-X′_{N} are synchronized to the received composite set of microbursts C. This is accomplished, for example, using synchronization reference streams or pilot stream techniques, or via a separate synchronization signal (not shown) provided to the decoder 30. For example, synchronizing the variable time interval samplers X′₁-X′_{N} to the received composite set of microbursts C is achieved, as in CDMA systems, using one or more pilot channels with Walsh coding to provide a pilot stream.

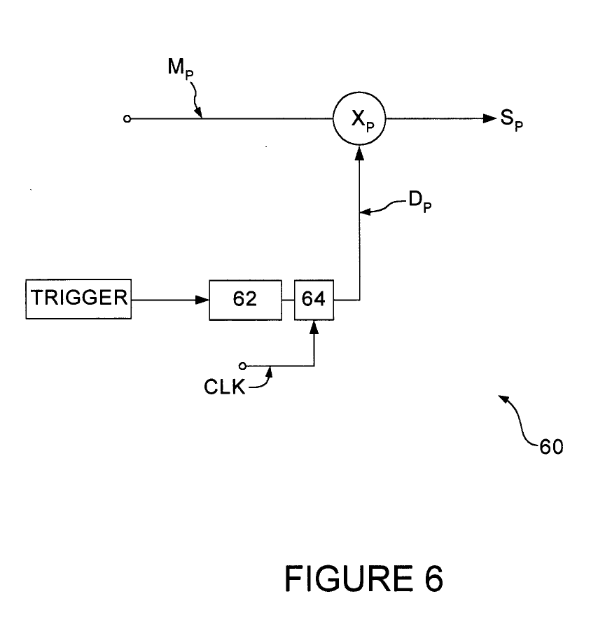

FIG. 6 shows an example of a pilot synchronization system 60 suitable for synchronizing the time dispersion code generators GEN′₁-GEN′_{N} with the composite set of microbursts C received by the decoder 30. A pilot symbol sequence S_{P}, either embedded within the composite set of microbursts C or transmitted separately from the composite set C, is encoded as a pilot series of microbursts M_{P} synchronized to the burst rate R_{BURST} of the microbursts μ within the composite set of microbursts C. The pilot series of microbursts M_{P} is then received by the pilot synchronization system 60. A programmable delay element 62 triggers a code generator 64 that generates a pilot dispersion sequence D_{P} to drive a sampler X_{P}. The programmable delay element 62 introduces successive delays in the triggering of the code generator 64 until the pilot symbol sequence S_{P} is recovered at a conditioner 66. The delay in the trigger that results in the recovery of the pilot symbol sequence S_{P} is used to establish synchronization of the time dispersion code generators GEN′₁-GEN′_{N} with the composite set of microbursts C.

Once the time dispersion code generators GEN′₁-GEN′_{N} are synchronized with the composite set of microbursts C, the series of microbursts M′₁-M′_{N} that result at the outputs of the variable time interval samplers X′₁-X′_{N} are applied to a conditioner 32 that reconstructs or otherwise extracts the symbol streams S₁-S_{N} from the corresponding series of microbursts M′₁-M′_{N}. The conditioner 32 is implemented with any circuit or system suitable for mapping various series of microbursts M′₁-M′_{N} to corresponding symbols Y_{X}. Typically, the conditioner is a processor with memory, suitable for performing the mapping, a FPGA (field programmable gate array), DSP (digital signal processor) or other logic circuit that averages or integrates the various series of microbursts M′₁-M′_{N} over time intervals equivalent to the symbol period 1/R_{S} of the symbols Y_{X} to extract the symbol streams S₁-S_{N}.

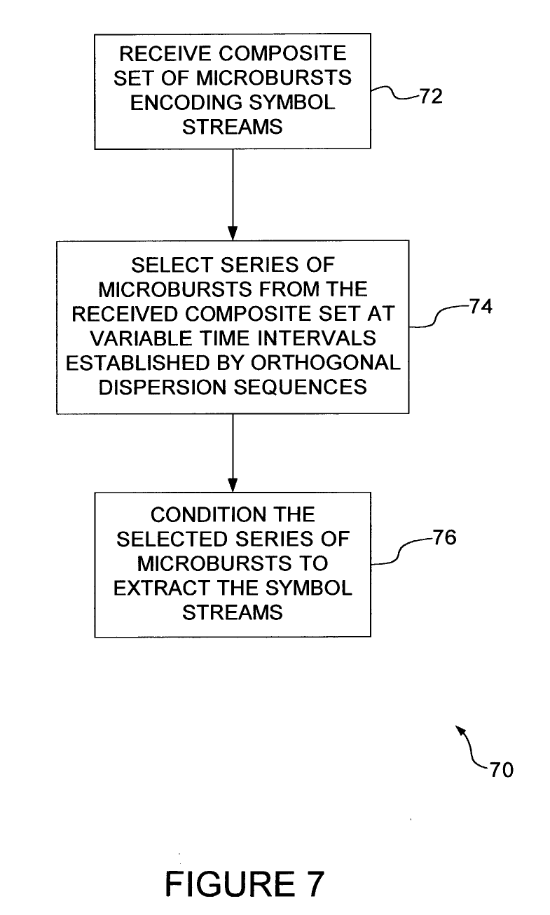

FIG. 7 shows a flow diagram of a symbol decoding method 70 constructed according to a fourth embodiment of the present invention. In step 72 of the method 70, the composite set of microbursts C encoding the symbol streams S₁-S_{N} is received. In step 74, the one or more series of microbursts M′₁-M′_{N} are selected from the received composite set of microbursts C, wherein the microbursts μ within each of the series of microbursts are separated by variable time intervals Tvarₓ established by the corresponding dispersion sequences D′₁-D′_{N} that are orthogonal, where orthogonal refers to the dispersion sequences D′₁-D′_{N} being sufficiently orthogonal to provide cross-correlations between each of the dispersion sequences D′₁-D′_{N} that are either zero, or sufficiently low to make each of the series of microbursts M₁-M_{N} statistically independent. In step 76, the selected series of microbursts M′₁-M′_{N} are conditioned to extract the encoded symbol streams S₁-S_{N}.

While the embodiments of the present invention have been illustrated in detail, it should be apparent that modifications and adaptations to these embodiments may occur to one skilled in the art without departing from the scope of the present invention as set forth in the following claims.

What is claimed is:

1. A symbol encoder, comprising:
a series of variable time interval samplers receiving corresponding symbol streams that are synchronous each other; and
one or more time dispersion code generators providing a corresponding dispersion sequence to each of the variable time interval samplers in the series to activate the variable time interval samplers to each generate a corresponding series of microbursts coherent with the received symbol streams and separated by varying time intervals established by the provided dispersion sequences, wherein the dispersion sequences are orthogonal.

2. The symbol encoder of claim 1 wherein the dispersion sequences provided by the one or more time dispersion code generators are repetitive.

3. The symbol encoder of claim 2 wherein the dispersion sequences have repetition rates coinciding with symbol rates of the corresponding symbol streams received by the series of variable time interval samplers.

4. The symbol encoder of claim 1 wherein the series of microbursts generated by the variable time interval samplers are clocked at burst rates that are integer multiples of the symbol rates of the symbol streams received by the variable time interval samplers.

5. The symbol encoder of claim 1 further comprising a combiner coupled to the one or more variable time interval samplers and combining the generated series of microbursts into a composite set of microbursts.

6. The symbol encoder of claim 5 further including at least one modulator coupled to at least one of the one or more variable time interval samplers and the combiner, providing a modulated version of the composite set of microbursts.

7. The symbol encoder of claim 1 wherein each generated series of microbursts has at least one of an amplitude, a pulse width, a pulse shape and a pulse duration established according to the symbol streams received by the one or more variable time interval samplers.

8. A symbol encoding method, comprising:
receiving one or more synchronized symbol streams; and
representing each of the symbol streams by a corresponding series of microbursts wherein the microbursts within each series are separated by variable time intervals established by a corresponding dispersion sequence.

9. The method of claim 8 wherein representing each of the received symbol streams includes at least one of sampling, multiplying, mixing and modulating of each one of the one or more symbol streams by one of a waveform and a vector depicting the corresponding dispersion sequence.

10. The method of claim 8 further including repeating the dispersion sequences at repetition rates that coincides with symbol rates of the received one or more symbol streams.

11. The method of claim 10 further including clocking the series of microbursts at burst rates that are integer multiples of the symbol rates of the one or more symbol streams.

12. The method of claim 8 further comprising combining the series of microbursts into a composite set of microbursts.

13. The method of claim 12 further including providing a modulated version of the composite set of microbursts to a transmission medium.

14. The method of claim 8 wherein the series of microbursts represent symbols within the one or more symbol streams by at least one of a pulse amplitude, a pulse width, a pulse shape and a pulse duration of microbursts within the series of microbursts.

15. A symbol decoder, comprising:
a series of variable time interval samplers receiving a composite set of microbursts including one or more series of microbursts each encoded at a corresponding burst rate, the microbursts within each of the multiple series separated by varying time intervals;
a set of time dispersion code generators synchronized to the burst rate, providing a corresponding dispersion sequence to each of the variable time interval samplers in the series and driving the variable time interval samplers in the series to each select microbursts from the composite set of microbursts designated according to the corresponding dispersion sequence, wherein the dispersion sequences are orthogonal; and
a conditioner receiving the selected microbursts from the composite set of microbursts and extracting a corresponding symbol stream.

16. The symbol decoder of claim 15 wherein the dispersion sequences provided by the series of time dispersion code generators are repetitive.

17. The symbol decoder of claim 16 wherein the dispersion sequences have repetition rates coinciding with symbol rates of the corresponding symbol streams extracted by the conditioner.

18. A symbol decoding method, comprising:
receiving a composite set of microbursts encoding one or more symbol streams;
selecting one or more series of microbursts from the received composite set of microbursts, wherein the microbursts within each of the one or more series of microbursts are separated by variable time intervals established by corresponding dispersion sequences that are orthogonal; and
conditioning the selected one or more series of microbursts to extract from each of the one or more series of microbursts a corresponding one of the encoded symbol streams.

19. The symbol decoding method of claim 18 wherein selecting the one or more series of microbursts from the received composite set of microbursts includes at least one of sampling, multiplying, mixing and modulating of the received composite set of microbursts by one of a waveform and a vector depicting each of the corresponding dispersion sequences.

20. The symbol decoding method of claim 18 wherein conditioning the selected one or more series of microbursts includes integrating each of the one or more selected series of microbursts over an interval equal to a symbol period of the extracted symbol stream.
